(19) United States
(12) Patent Application Publication
(10) Pub. No.: US 2023/0013634 A1
(43) Pub. Date: Jan. 19, 2023

(54) LIFECYCLE MANAGEMENT ENGINE WITH AUTOMATED INTELLIGENCE

(71) Applicant: Walmart Apollo, LLC, Bentonville, AR (US)

(72) Inventors: Christopher Ryan Linn, Rogers, AR (US); Savio Francis Fernandes, Bardez (IN); Uruj Fatima, New Delhi (IN); Mandeep Singh, New Delhi (IN); Noyle Augustine Christopher, Bentonville, AR (US); Nimish Kumar, Bangalore (IN)

(73) Assignee: Walmart Apollo, LLC, Bentonville, AR (US)

(21) Appl. No.: 17/377,238

(22) Filed: Jul. 15, 2021

(51) Int. Cl. G06Q 40/00; G06Q 10/06; G06N 20/00

(52) U.S. Cl. CPC G06Q 40/12; G06Q 10/06315; G06N 20/00; G06Q 10/06393

(57) ABSTRACT

A system comprising one or more processors and one or more non-transitory computer-readable media storing computing instructions configured to run on the one or more processors and perform: estimating, using a machine learning model, a respective budget for expenditures based on respective parameters of each of one or more project initiatives associated with physical stores; determining, using a mixed integer linear programming formulation, a time window to execute the each of the one or more project initiatives; generating one or more respective recommendations for the each of the one or more project initiatives for a predetermined time period; and sending instructions to display the one or more respective recommendations on a graphical user interface, wherein the graphical user interface displays a respective status of each of the one or more respective recommendations. Other embodiments are disclosed.

### TECHNICAL FIELD

This disclosure relates generally relates to a lifecycle management engine.

### BACKGROUND

Sometimes, existing retail stores can undergo construction projects to remodel or perform other special projects. Such projects can involve a global coordination of multiple events from initiation to completion of the project.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for automatically generating one or more recommendations using a machine learning model, to implement one or more respective project initiatives for each of a set of physical stores, according to an embodiment;

FIG. 4 illustrates a flow chart for a method, according to another embodiment;

FIG. 5 illustrates a flow chart for a block of calculating an impact metric of the project initiative on the first physical store compared to another impact metric on a sister physical store, using k-nearest-neighbors, according to an embodiment of FIG. 4;

FIG. 6 illustrates a flow chart for a method of a project initiative lifecycle, according to an embodiment;

FIG. 7 illustrates a flow chart for a block of processing an intake of project initiative requests for consideration of whether or not to approve a project initiative for a physical store, according to an embodiment of FIG. 6;

FIG. 8 illustrates a flow chart for a block of adjusting one or more parameters in each project initiative prior to execution of a remodel and/or a special project, according to an embodiment of FIG. 6;

FIG. 9 illustrates a flow chart for a block of executing each project initiative of the set of project initiatives, according to an embodiment of FIG. 6; and

FIG. 10 illustrates an exemplary graphical user interface, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than 30 seconds, 1 minute, 5 minutes, or another suitable time delay period.

### DESCRIPTION OF EXAMPLES OF EMBODIMENTS

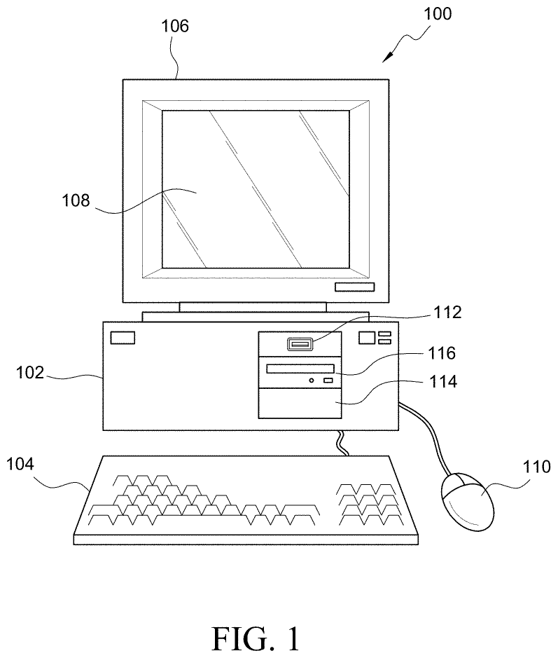

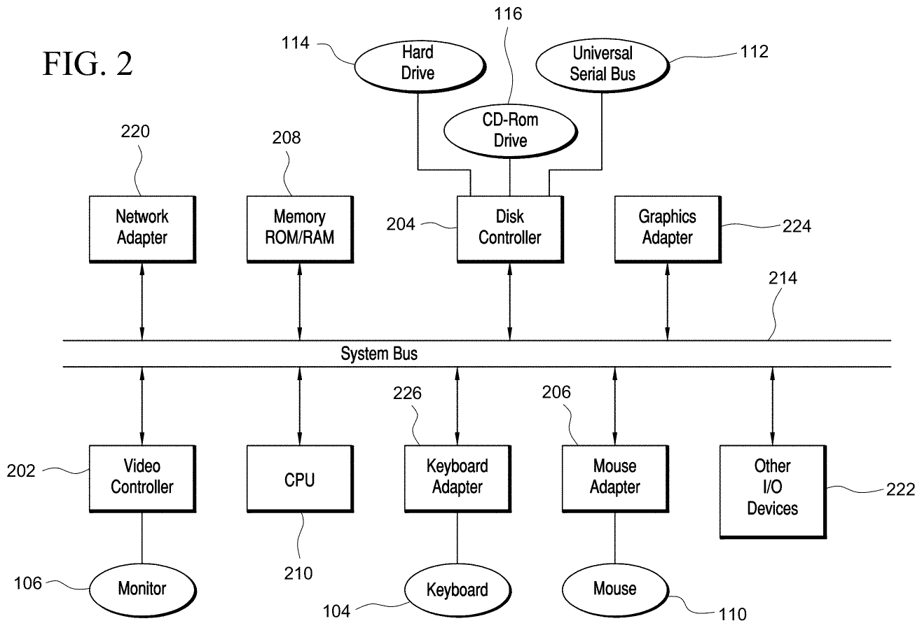

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

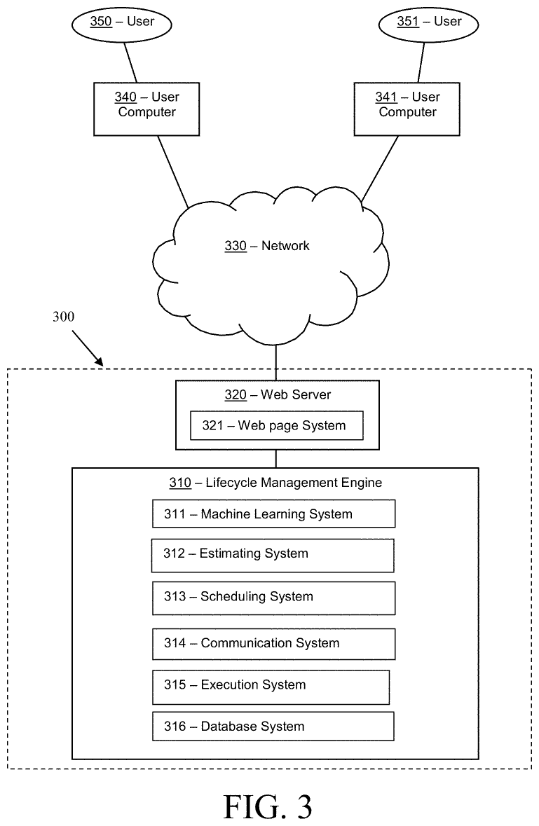

Turning ahead in the drawings, FIG. 3 illustrates a block diagram of a system 300 that can be employed for automatically generating one or more recommendations using a machine learning model, to implement one or more respective project initiatives for each of a set of physical stores, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In many embodiments, system 300 can include a lifecycle management engine 310 and/or a web server 320. Lifecycle management engine 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host two or more of, or all of, lifecycle management engine 310 and/or web server 320. Additional details regarding lifecycle management engine 310 and/or web server 320 are described herein.

In a number of embodiments, each of lifecycle management engine 310 and/or web server 320 can be a special-purpose computer programed specifically to perform specific functions not associated with a general-purpose computer, as described in greater detail below.

In some embodiments, web server 320 can be in data communication through network 330 with one or more user computers, such as user computers 340 and/or 341. Network 330 can be a public network, a private network or a hybrid network. In some embodiments, user computers 340-341 can be used by users, such as users 350 and 351, which also can be referred to as associates, in which case, user computers 340 and 341 can be referred to as associate computers. In many embodiments, web server 320 can host one or more sites (e.g., websites) that allow users to browse and search for initiatives and/or physical stores, and/or another suitable activity.

In some embodiments, an internal network that is not open to the public can be used for communications between lifecycle management engine 310 and/or web server 320 within system 300. Accordingly, in some embodiments, lifecycle management engine 310 (and/or the software used by such systems) can refer to a back end of system 300, which can be operated by an operator and/or administrator of system 300, and web server 320 (and/or the software used by such system) can refer to a front end of system 300, and can be accessed and/or used by one or more users, such as users 350-351, using user computers 340-341, respectively. In these or other embodiments, the operator and/or administrator of system 300 can manage system 300, the processor(s) of system 300, and/or the memory storage unit(s) of system 300 using the input device(s) and/or display device(s) of system 300.

In certain embodiments, user computers 340-341 can be desktop computers, laptop computers, a mobile device, and/or other endpoint devices used by one or more users 350 and 351, respectively. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Meanwhile, in many embodiments, lifecycle management engine 310 also can be configured to communicate with and/or include one or more databases, such as database system 316. The one or more databases can include receiving project initiative, storing data, for example, among other data as described herein, such as described herein in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between lifecycle management engine 310, network 330, and/or the one or more databases (e.g., 316) can be implemented using any suitable manner of wired and/or wireless communication. Accordingly, lifecycle management engine 310 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, lifecycle management engine 310 can include database system 316, a machine learning system 311, an estimating system 312, a scheduling system 313, a communication system 314, and/or an execution system 315. In many embodiments, the systems of lifecycle management engine 310 can be modules of computing instructions (e.g., software modules) stored at non-transitory computer readable media that operate on one or more processors. In other embodiments, the systems of lifecycle management engine 310 can be implemented in hardware. Lifecycle management engine 310 can be a computer system, such as computer system 100 (FIG. 1), as described above, and can be a single computer, a single server, or a cluster or collection of computers or servers, or a cloud of computers or servers. In another embodiment, a single computer system can host lifecycle management engine 310. Additional details regarding lifecycle management engine 310 and the components thereof are described herein.

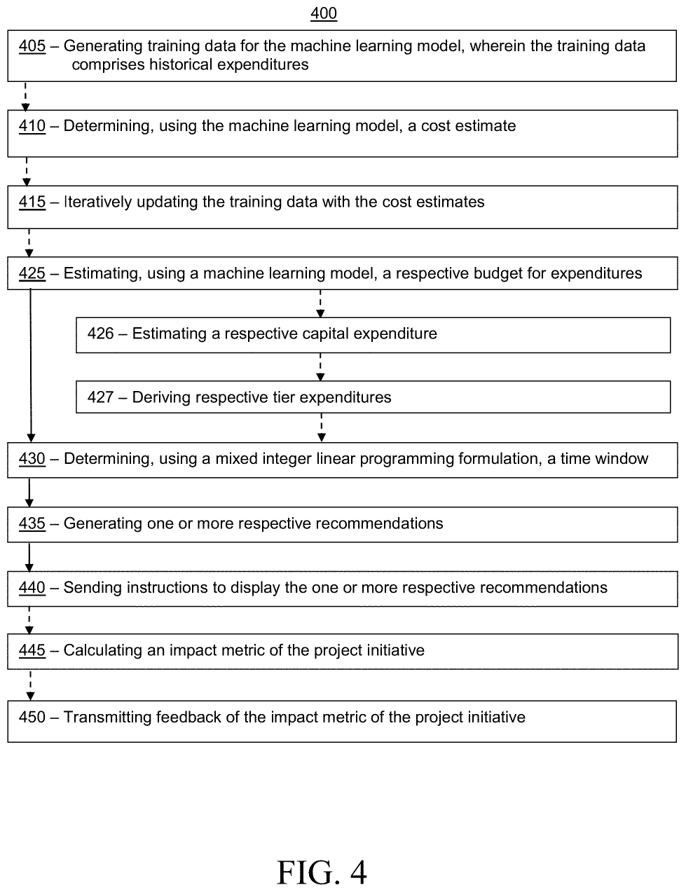

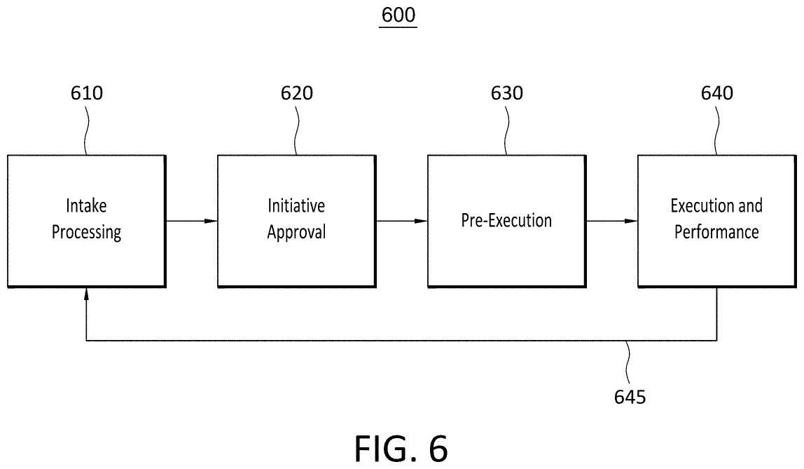

Jumping ahead in the drawings, FIG. 6 illustrates a flow chart for a method 600 of a project initiative lifecycle, according to an embodiment. Method 600 can include recommending a project initiative for a remodel within a time period, including calculating performance metrics of the project initiative. Method 600 also can illustrate a project initiative lifecycle recommended for a special project within the time period. Method 600 further can illustrate how site selection models can learn via data from a feedback loop by tracking metrics during and after execution of the project initiative. Method 600 can be similar to method 400 (FIG. 4, described below). Method 600 can be employed in many different embodiments and/or examples not specifically depicted or described herein. In some embodiments, the procedures, the processes, and/or the activities of method 600 can be performed in the order presented or in parallel. In other embodiments, the procedures, the processes, and/or the activities of method 600 can be performed in any suitable order. In still other embodiments, one or more of the procedures, the processes, and/or the activities of method 600 can be combined or skipped. In several embodiments, system 300 (FIG. 3) can be suitable to perform method 600 and/or one or more of the activities of method 600.

In these or other embodiments, one or more of the activities of method 600 can be implemented as one or more computing instructions configured to run at one or more processors and configured to be stored at one or more non-transitory computer-readable media. Such non-transitory computer-readable media can be part of a computer system such as lifecycle management engine 310 and/or web server 320. The processor(s) can be similar or identical to the processor(s) described above with respect to computer system 100 (FIG. 1).

In several embodiments, method 600 can include a block 610 of processing an intake of project initiative requests for consideration of whether or not to approve a project initiative for a physical store. Block 610 can include receiving requests from users for remodels and/or special projects during a time period in advance of a start date, such a time period can be 12 months, 13 months, and/or another suitable time period.

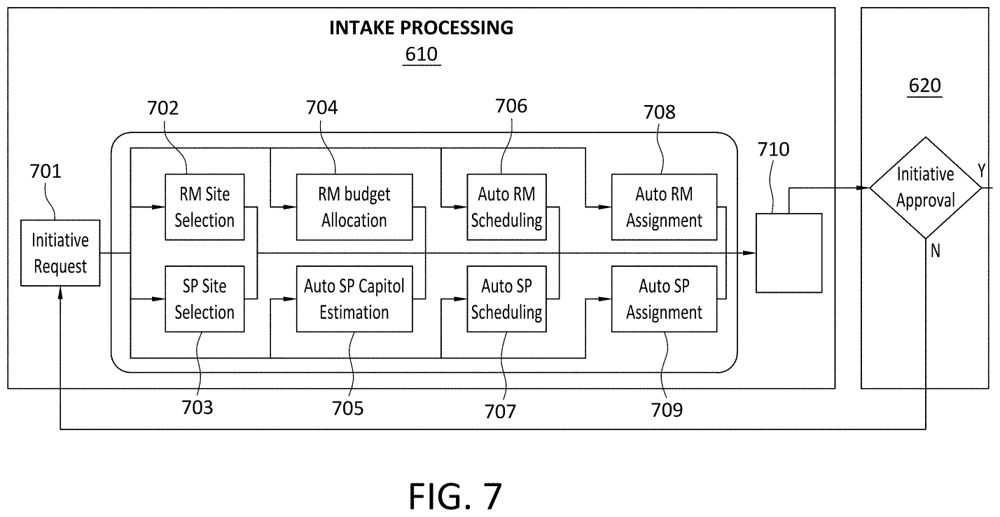

In several embodiments, method 600 can proceed after block 610 to a block 620. In many embodiments, block 610 and block 620 can be implemented as described below in connection with FIG. 7. In various embodiments, method 600 can include block 620 of determining whether or not to approve each project initiative for consideration within the set of project initiatives during the predetermined time period. In some embodiments, block 620 can include determining whether or not a project initiative exceeds a project initiative threshold. If block 620 is yes, method 600 can proceed to a block 630. Otherwise, block 620 is no, method 600 can return to block 610 and/or a block 701 (FIG. 7, described below).

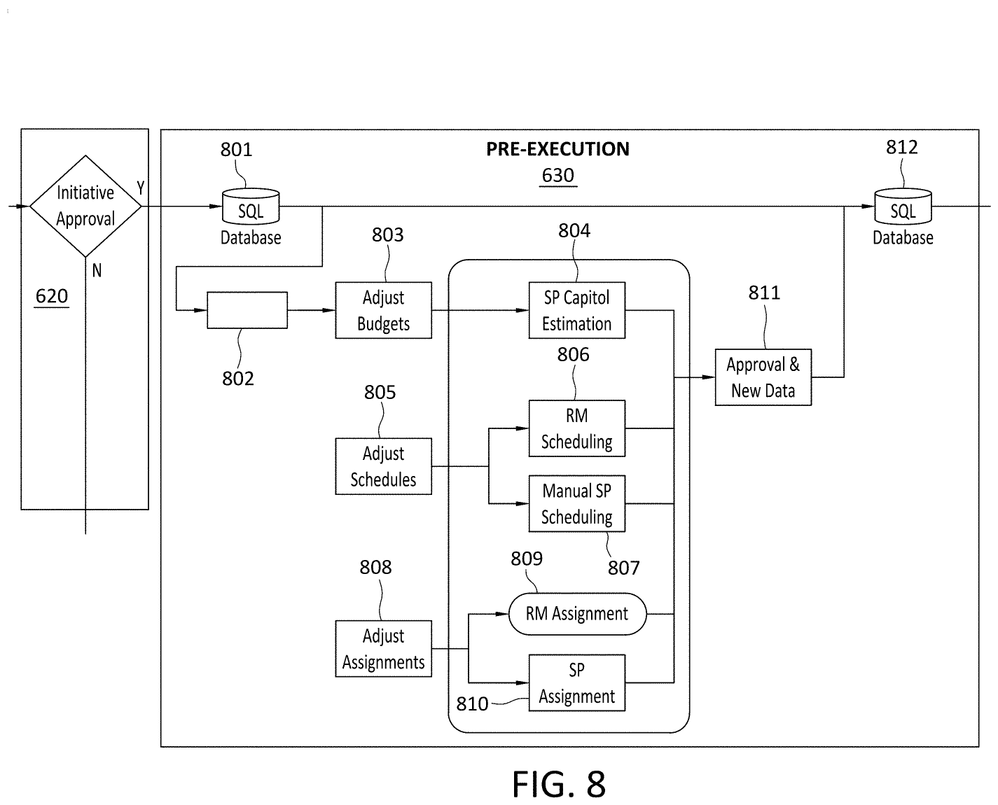

In many embodiments, method 600 can proceed after block 620 to a block 630 and/or a block 640. In some embodiments, block 620 can skip block 630 and proceed to block 640. In a number of embodiments, method 600 can include block 630 of adjusting one or more parameters in each project initiative prior to execution of a remodel and/or a special project. In many embodiments, method 600 can proceed after block 630 to a block 640. In some embodiments, block 630 can be implemented as described below in connection with FIG. 8.

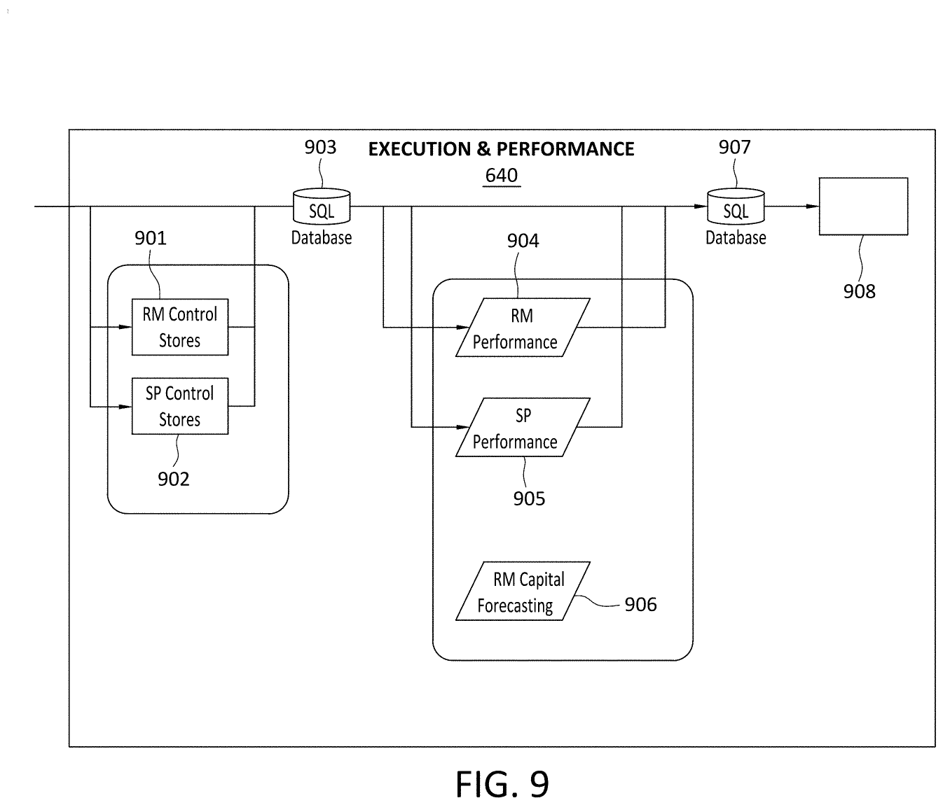

In some embodiments, method 600 can include block 640 of executing each project initiative of the set of project initiatives, which can include tracking one or more performance metrics of each project initiative. In several embodiments, block 640 can be implemented as described below in connection with FIG. 9.

Turning ahead in the drawings, FIG. 7 illustrates a flow chart for block 610 of processing an intake of project initiative requests for consideration of whether or not to approve a project initiative for a physical store, according to an embodiment. Block 610 can be employed in many different embodiments and/or examples not specifically depicted or described herein. In some embodiments, the procedures, the processes, and/or the activities of block 610 can be performed in the order presented or in parallel. In other embodiments, the procedures, the processes, and/or the activities of block 610 can be performed in any suitable order. In still other embodiments, one or more of the procedures, the processes, and/or the activities of block 610 can be combined or skipped.

In many embodiments, block 610 can include a block 701 of transmitting each request for a project initiative including a request for a remodel and/or a special project. In some embodiments, project initiatives can be requested by a user. In several embodiments, block 701 can include receiving returned initiative requests unapproved in block 620 (FIG. 6) for storage and/or for further processing at a later date. In many embodiments, block 610 can proceed after block 701 to a block 702 and/or a block 703. In several embodiments, a physical store can be selected for remodel and/or a special project to be executed concurrently, consecutively, and/or during another slot within the predetermined time period.

In some embodiments, block 610 can include block 702 of selecting a physical store for a remodel at a site (e.g., location or region), by using an ensemble of algorithms, based on one or more parameters of the site selection process. In several embodiments, estimating expenditures for a remodel can be based on RF (Random Forest) Regression In some embodiments, estimating lift metrics for a remodel can be based on, using an ensemble of classification algorithms, including two or more classification algorithms, such as RF regression, XGB (XGBoost), and/or SVM (support vector machine). In various embodiments, estimating disruption metrics for each physical store can be based on using an ensemble of classification algorithms include two or more of RF, XGB, OLR (Ordinal Logistic Regression), and/or SVM. In some embodiments, optimization of the selection of a physical store for a remodel can be based on mixed integer linear programming.

In several embodiments, block 610 can include block 703 of selecting a physical store for a special project at a site based on using linear ranking. In some embodiments, linear ranking can include creating a normalized score based on a variety of metrics. In various embodiments, ranking the normalized scores can be based on a highest to lowest value, wherein selecting the physical store with the highest score can be selected for a special project at a site. In many embodiments, block 610 can proceed after block 702 to a block 704 and after block 703 to a block 705.

In various embodiments, block 610 can include block 704 of allocating budgets for a remodel of a physical store using historical averages.

In some embodiments, block 610 also can include block 705 of automatically estimating a capital expenditure for a special project of a physical store. In several embodiments, automatically estimating the capital expenditure can include using two or more ensemble algorithms including linear mixed model, LASSO (Least Absolute Shrinkage and Selection Operator), KNN (k-nearest neighbor), and/or by using historical averages. In some embodiments, block 610 can proceed after block 704 to a block 706 and/or after block 705 to a block 707.

In various embodiments, block 610 can include block 706 of automatically scheduling a time window for a remodel using mixed integer linear programing.

In several embodiments, block 610 can include block 707 of automatically scheduling a time window for a special project using mixed integer linear programing. In many embodiments, block 610 can proceed after block 706 to a block 708 and/or after block 707 to a block 709.

In various embodiments, block 610 can include block 708 of automatically assigning one or more associates to manage each remodel by using mixed integer linear programming.

In some embodiments, block 610 can include block 709 of automatically assigning one or more associates to manage each special project by using mixed integer linear programming. In various embodiments, block 610 can proceed after block 708 and/or block 709 to a block 710.

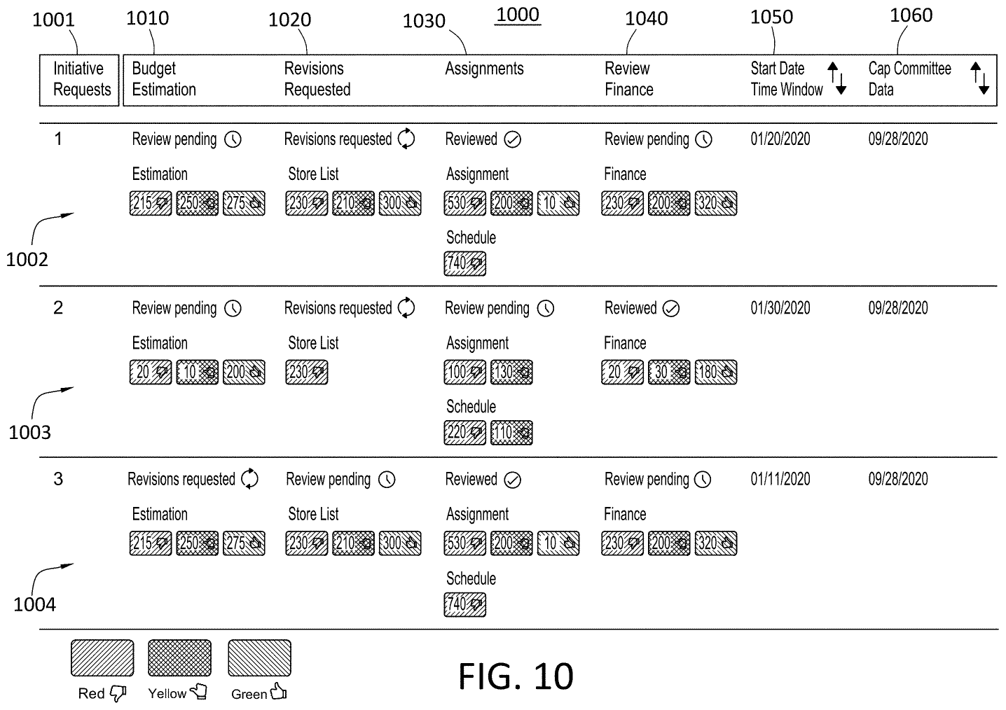

In several embodiments, block 610 can include block 710 of dynamically displaying a status of each project initiative on a graphical user interface. The display can be similar to identical to the graphical user interface 1000 (FIG. 10, described below).

Turning ahead in the drawings, FIG. 8 illustrates a flow chart for block 630 of adjusting one or more parameters in each project initiative prior to execution of a remodel and/or a special project, according to an embodiment. Block 630 illustrates a method of providing customizable options for scenario-based results that can include adjusting one or more parameters of a project initiative. For example, a scenario-based result can include a temporary stoppage of executing a project initiative due to a pandemic, a leave of absence of an associate, and/or another suitable scenario-based result. Block 630 can be employed in many different embodiments and/or examples not specifically depicted or described herein. In some embodiments, the procedures, the processes, and/or the activities of block 630 can be performed in the order presented or in parallel. In other embodiments, the procedures, the processes, and/or the activities of block 630 can be performed in any suitable order. In still other embodiments, one or more of the procedures, the processes, and/or the activities of block 630 can be combined or skipped.

Upon receiving approval for a project initiative to be executed, block 630 can generate customizable options, by running various algorithms, in response to one or more scenario-based events that can stop execution of a project initiative. In some embodiments, method 600 (FIG. 6) can skip block 630 and proceed to block 640 (FIGS. 6 and 9).

In some embodiments, block 630 can include a block 801 of receiving project initiatives approved for execution stored in a database. In several embodiments, block 630 can proceed after block 801 to a block 802 and/or a block 812.

In various embodiments, block 630 can include block 802 of displaying on a graphical user interface a status of each project initiative from results received from block 620 (FIG. 6). The graphical user interface can be similar or identical to graphical user interface 1000 (FIG. 10, described below). In some embodiments, block 630 can proceed after block 802 to a block 803 of adjusting budgets, a block 805 of adjusting time schedules, and/or a block 808 of adjusting assignments.

In several embodiments, block 630 can include block 803 of generating revised or adjusted budget estimates addressing one or more scenario-based events. In many embodiments, block 630 can proceed after block 803 to a block 804. In some embodiments, block 630 can include block 804 of revising capital budgets for special projects and/or remodels based on two or more ensemble algorithms including linear mixed model, LASSO, KNN, and/or historical averages. In many embodiments, block 804 also can be performed manually.

In various embodiments, block 630 can include block 805 of generating a revised or a rescheduled time window addressing one or more scenario-based events. In some embodiments, block 630 can proceed after block 805 to a block 806 and/or a block 807. In several embodiments, block 630 can include block 806 of adjusting or rescheduling a time window for a remodel by using mixed integer linear programing. In some embodiments, block 630 can include block 807 of adjusting and/or rescheduling a time window for a special project by using mixed integer linear programing. In many embodiments, block 806 and/or block 807 also can be performed manually.

In some embodiments, block 630 can include block 808 of generating a revised or an adjusted assignment addressing one or more scenario-based events. In several embodiment, block 630 can proceed after block 808 to a block 809 and a block 810. In many embodiments, block 630 can include block 809 of adjusting or rescheduling assignments for a remodel by using mixed integer linear programing. In many embodiments, block 630 can include block 810 of adjusting or rescheduling assignments for a special project by using mixed integer linear programing. In several embodiments, block 809 and/or block 810 also can be performed manually.

In various embodiments, block 630 can proceed after block 804, block 806, block 807, block 809, and/or block 810 to a block 811. In some embodiments, block 630 can include block 811 of receiving approval of the revised estimates and/or scheduling of block 803 (adjust budgets), block 805 (reschedule time windows), and/or block 808 (reassign associates). In several embodiments, block 630 can proceed after block 811 to a block 812.

In some embodiments, block 630 can include block 812 of storing data from block 801 and/or block 811.

Turning ahead in the drawings, FIG. 9 illustrates a flow chart for block 640 of executing each project initiative of the set of project initiatives, according to an embodiment. Block 640 illustrates a method of executing project initiatives including displaying the status of each project initiative on a graphical user interface block 908. The display can be similar or identical to graphical user interface 1000 (FIG. 10, described below). Block 640 also includes tracking one or more performance metrics before, during, and after the execution of the project initiative. Block 640 can be employed in many different embodiments and/or examples not specifically depicted or described herein. In some embodiments, the procedures, the processes, and/or the activities of block 640 can be performed in the order presented or in parallel. In other embodiments, the procedures, the processes, and/or the activities of block 640 can be performed in any suitable order. In still other embodiments, one or more of the procedures, the processes, and/or the activities of block 640 can be combined or skipped.

In many embodiments, block 640 can proceed after block 812 (FIG. 8) to a block 901 and/or a block 902. In several embodiments, block 640 can include block 901 of generating a set of sister stores that are similar to each physical store, using KNN, to use one or more sister stores as control stores for remodels. In some embodiments, block 640 can include block 902 of generating a set of sister stores to each physical store, using KNN, to use one or more sister stores as control stores for special projects. In various embodiments, block 640 can proceed after block 901 and/or block 902 to a block 903.

In some embodiments, block 640 can include block 903 of storing data from block 901 and/or block 902. In various embodiments, block 640 can proceed to a block 904, a block 905, and a block 907.

In several embodiments, block 640 can include block 904 of tracking data for a period of time measuring remodel performance metrics based on a block 906 of forecasting remodel capital budgets using historical averages. In some embodiments, block 640 can include block 905 of tracking data for a period of time measuring special projects performance metrics. In various embodiments, block 640 can proceed after block 904 and block 905 to block 907.

In some embodiments, block 640 can include block 907 of storing data from block 903, block 904, and/or block 905. In several embodiments, block 640 can proceed after block 907 to a block 908. In various embodiments, block 640 can include block 908 of a graphical user interface displaying a status of each project initiative from results received from block 903 and block 907. The display can be similar to identical to graphical user interface 1000 (FIG. 10, described below).

Turning ahead in the drawings, FIG. 10 illustrates an exemplary webpage display of a graphical user interface 1000, according to an embodiment. In some embodiments, graphical user interface 1000 can display a status indicator for one or more project initiatives. In several embodiments, graphical user interface 1000 can take a shape and/or a format of a display with columns and rows, including using multi-colored status flags or icons to indicate a current status of each project initiative during the lifecycle of the project initiative. In several embodiments, multi-colored flags can represent whether a project initiative passes certain checks. For example, a color green can represent a number of stores that passed the first threshold, yellow the second threshold, and red, none of the thresholds. In various embodiments, multi-colored status flags also can represent a status as to whether a project initiative is approved, pending approval, or not approved at a particular period of time corresponding to each event depicted in each column. For example, a color green can represent approval, a color yellow can represent pending or pending an outcome, and/or a color red can represent not approved or disapproved. In some embodiments, status flags can be dynamically updated in real-time on the graphical user interface 1000.

In various embodiments, graphical user interface 1000 can include a display bar located at the top of a webpage listing project initiatives requested. In several embodiments, each physical store of an ordered list of physical stores, based on ranking, can be assigned an identification number. In various embodiments, ranking can include assigning each of the physical stores of a listing of project initiatives a color code based on model criteria and thresholds In some embodiments, each column can describe a stage of review and/or whether revisions were requested. Such descriptions can include text indicating a review pending, revisions requested, and/or another suitable description. In various embodiments, a respective list of identification numbers can be listed under each column heading in the shape of a box, a flag, an icon, and/or another suitable shape. In some embodiments, for each column displayed on graphical user interface 1000 can include one or more corresponding rows for each type of project initiative, where each row can represent a respective sub-list of physical stores displayed by identification (ID) numbers.

In some embodiments, column 1001 can identify a type of project initiative, such as whether the project initiative is a remodel and/or a special project. In many embodiments, column 1001 can include one or more rows identifying each type of project initiative for the rows, such as a row 1002 (i.e., a remodel), a row 1003 (i.e., a special project), and a row 1004 (i.e., a special project).

In some embodiments, graphical user interface 1000 can include a column 1010 of estimating a budget by type of project initiative for each physical store on the ordered list of physical stores, including a capital budget and a tier budget, where the tier budget is derived from the capital budget. The colors of each icon can indicate a potential accuracy of an estimated budget. For example, the color green can indicate that the estimated budget falls within or does not exceed a predetermined threshold as compared to an average historical budget for a project type and/or project initiative. The color yellow can indicate that the estimated budget exceeds a predetermined threshold that can still be acceptable. The color red can indicate that the estimated budget exceeded the predetermined threshold thus, should be reviewed by the user prior to acceptance. The color red also can indicate that an estimated budget has not yet been created.

For example, row 1002 under column 1010 can illustrate whether a budget has been estimated for the physical store shown in row 1002. In this example, row 1002 indicates budget estimation for physical store ID number 275 as completed (green color) while budget estimates for physical store ID number 250 as pending (yellow color) and budget estimates for physical store ID number 215 as not completed (red color). Similarly for rows 1003 and 1004 under column 1010 whether a budget has been estimated for each physical store listed under column 1010.

In many embodiments, graphical user interface 1000 can include a column 1020 of revising or adjusting one or more respective parameters of each project initiative as requested by a user. In some embodiments, when no requests for revisions are received, column 1020 can be skipped and graphical user interface 1000 can move to a column 1030. For example row 1002 under column 1020 can illustrate whether a request for a revised budget has been received and/or updated. In this example, row 1002 indicates estimates for revisions for physical store ID number 300 as completed (green color) while estimates for revisions for physical store ID number 210 as pending (yellow color) and estimates for revisions for physical store ID number 230 as not completed (red color). Similarly for rows 1003 and 1004 under column 1010 whether or not respective estimates for revisions to the budget were executed for each physical store listed under column 1010.

In various embodiments, column 1020 also can indicate whether the physical stores uploaded on a store list previously requested can be selected as a good fit for the project initiatives. For example, when an initiative is requested, a user can provide a first store list. The first store list can be compared to a second store list created and recommended by the site model (e.g., model). If the first store and the second store match, the first store can receive a green colored flag or icon. If the first store and the second store do not match, the first store can be listed in a second tier by the site selection model where the first store can receive a yellow colored flag or icon. Similarly, each store on the first store list can receive a red colored flag or icon indicating that the store is not a fit at a certain time.

In several embodiments, graphical user interface 1000 can include a column 1030 of assigning associates to project initiatives that are selected for execution. For example, row 1002 under column 1030 can illustrate whether or not respective associates were assigned for each physical store listed under column 1030. In this example, row 1002 indicate assignments for physical store ID number 10 as completed (green color) while assignments for physical store ID number 200 as pending (yellow color), assignments for physical store ID number 530 as not completed (red color) and assignments scheduled for physical store ID 740 as not completed (red color). Similarly for rows 1003 and 1004 under column 1030 whether or not associates were assigned or each physical store listed under column 1030.

In various embodiments, column 1030 of assigning associates to project initiatives also can include a color code associated with a travel distance of an associated assigned to a project initiative. For example, the color green can indicate associates assigned live near the location of the physical store. The color yellow can indicate associates assigned can include some that live nearer and others live farther from the location of the physical store. The color red can indicate either that the physical store has less than a full number of associates assigned to a physical store location or that the associates assigned to the physical store location live farther away from the location.

In various embodiments, graphical user interface 1000 can include a column 1040 of reviewing finances of each of the project initiatives for each physical store prior to execution to allow for updates to the estimated capital budget expenses or tier expenses. For example, row 1002 under column 1010 can illustrate whether or not, prior to execution, finances were reviewed for each physical store listed under column 1010, row 1002. In this example, row 1002 indicates finance review for physical store ID number 320 as completed (green color) while finance review for physical store ID number 200 as pending (yellow color) and finance review for physical store ID number 230 as not completed (red color). Similarly for rows 1003 and 1004 under column 1040 whether or not respective finances were reviewed for each physical store listed under column 1010.

In some embodiments, column 1040 of reviewing finances also can include creating a score based on various metrics reviewed. For example, the color green can indicate that the physical store received a high score associated with high financial health, thus the physical store can handle a project initiative. The color yellow can indicate that the physical store received a medium score associated with less than financial health, thus the physical store can be reviewed for further consideration. The color red can indicate that the physical store received a low score associated with low financial health, thus the physical store cannot handle the project initiative at this time.

In several embodiments, graphical user interface 1000 can include a column 1050 of estimating a start date for a time window to execute the project initiative. For example, row 1002 under column 1050 can illustrate whether or not scheduling a state date for a time window has been generated for each physical store listed under column 1050, row 1002. In this example, row 1002 indicates scheduling a start date for physical store ID number 275 as completed (green color) while scheduling a start date for physical store ID number 250 as pending (yellow color) and scheduling a start date for physical store ID number 215 as not completed (red color). Similarly for rows 1003 and 1004 under column 1050, indicates a status of whether or not a respective start date was generated for each physical store listed under column 1050.

In many embodiments, graphical user interface 1000 can include a column 1060 of scheduling a date where the project initiative for the physical store can be reviewed for either approval or rejection.

Turning back in the drawings, FIG. 4 illustrates a flow chart for a method 400, according to another embodiment. In some embodiments, method 400 can be a method of using automated intelligence to output one or more recommendations throughout a project initiative lifecycle. Method 400 also can involve automatically approving or disapproving, using an ensemble of algorithms, execution of one or more project initiatives throughout the lifecycle of the project initiative. Method 400 is merely exemplary and is not limited to the embodiments presented herein. Method 400 can be employed in many different embodiments and/or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped. In several embodiments, system 300 (FIG. 3) can be suitable to perform method 400 and/or one or more of the activities of method 400.

In these or other embodiments, one or more of the activities of method 400 can be implemented as one or more computing instructions configured to run at one or more processors and configured to be stored at one or more non-transitory computer-readable media. Such non-transitory computer-readable media can be part of a computer system such as lifecycle management engine 310 and/or web server 320. The processor(s) can be similar or identical to the processor(s) described above with respect to computer system 100 (FIG. 1).

In various embodiments, method 400 optionally can include a block 405 of generating training data for the machine learning model, where the training data comprises historical expenditures associated with the respective parameters of each of the one or more project initiatives within a historical time period.

In several embodiments, method 400 also optionally can include a block 410 of determining, using the machine learning model, a cost estimate for a project initiative of the each of the one or more project initiatives based on the training data. In various embodiments, training data for the machine learning model can include historical records of capital expenditures, project initiatives, and/or physical store data over a period of time, such a period of time can include three years, four years, ten years, and/or another suitable period of time. Input for the machine learning model can include project initiative identifications (ID), physical store numbers, a duration of the project initiative, a time of year, prototype details, and/or another suitable input metric. Output for the machine learning model based on the training data can include a cost estimate of a project initiative.

In a number of embodiments, method 400 further optionally can include a block 415 of iteratively updating the training data with the cost estimates for the each of the one or more project initiatives. In some embodiments, iteratively updating the training data can be conducted in real time, a predetermined schedule of time, and/or another suitable time period.

Conventionally, manual processes can include using spreadsheets to determine budgets and time windows that can lead to inconsistent results and suboptimal solutions. Often data relied upon can be spread out across one or more tools used when the process is manual in an attempt to streamline projects and estimate various costs with minimal efficiency using many computer and other resources. Such manual processes can lack a one stop solution for executing and tracking project initiatives on a large scale.

In various embodiments, method 400 additionally can include a block 425 of estimating, using a machine learning model, a respective budget for expenditures based on respective parameters of each of one or more project initiatives associated with physical stores. In some embodiments, estimating a budget for expenditures can be advantageous by establishing an automated capital estimation process for special projects to drive better utilization of overall budgets and to reduce hours by associated spent on the estimation process. Block 425 can be similar or identical to the activities described in connection with blocks 704-705 (FIG. 7). For example, a large retail operation can operate thousands of physical stores across the United States in both urban and rural locations. In following with the example, a large retail operation can operate thousands of physical stores scattered across each state of the union.

In some embodiments, the machine learning model can include an ensemble of algorithms comprising two or more of: linear regression, linear mixed model, median based model, least absolute shrinkage and selection operator (LASSO), or k-nearest neighbor (KNN).

In many embodiments, using the linear mixed model can be based on fixed and random effects (initiatives) that can improve the estimates with more precise estimates. In several embodiments, data obtained on initiatives can vary on the execution count (samples) creating multiple models that can lead to overfitting due to low sample sizes. In some embodiments, these random effects can allow one model to be used rather than a model for each project type.

In some embodiments, using LASSO, (a regularization method) can avoid overfitting of the model. In several embodiments, by using an automatic feature selection, data can be refreshed and the model can automatically select the variables that are relevant. In many embodiments, LASSO can be increase the speed of computer resources (e.g., fast) in terms of outputting inferences and fitting.

In some embodiments, k-nearest neighbors (“KNN”) can be used for sub-tier levels using low sample sizes. In several embodiments, sub-tier levels can include the lower level items used to build up or calculate costs for an estimated budget. For example, a type of project initiative can include approximately 16 or more costs, such as construction costs, flooring costs, and/or another suitable cost of a project initiative.

In various embodiments, features can include project initiative types, bundling status, state, physical store age, duration of each project initiative, a prototype group, state and monthly commodity costs, additional initiative attributes, sub-tier levels, time of year, geographic weather conditions, and/or additional project initiative attributes.

In several embodiments, block 425 also can include estimating expenditures including a first stage of estimation beginning with the project initiative level cost based on the initiative type and a store number. In some embodiments, a first ensemble of algorithms can include using a linear mixed model and a median-based algorithm. In various embodiments, the linear mixed model can be based on fixed and random effects that can be optimal for groups with varied sample sizes since separate models might over-fit and where residuals need not be independent and homogenous. In many embodiments, using the median-based algorithm can include initiatives with low frequency. The ensemble of embodiments for estimating expenditures can be interchangeable with one or more other suitable algorithms.

In many embodiments, block 425 further can include estimating expenditures based on the output of the first stage by using a second ensemble of algorithms to derive a second stage of estimation of tier and/or sub-tier level costs breaking down the output into smaller components such as construction cost, and other smaller budgets. In some embodiments, the second ensemble of algorithms can include LASSO and KNN. In many embodiments, using LASSO can avoid overfitting, use feature selections and increase speed in terms of inferencing and fitting. In some embodiments, an advantage of using KNN can include an intuitive and simple approach used primarily for tier levels with low sample sizes, where KNN is not based on assumption with increased processing speeds.

In various embodiments, a capital estimation linear mixed model as used above can be expressed as:

Y=Xβ+Zγ+ε

where Y refers to a cost of a project, X refers to the fixed effects design matrix, β refers to the fixed-effects regression coefficients, Z refers to the random effects design matric, γ refers to the random effects, and ε refers to the residuals.

In several embodiments, block 425 can include automatically estimating budgets for special projects can include an ensemble model approach. In many embodiments, each of the one or more project initiatives can be a remodel and/or a special project. In various embodiments, a remodel can include an overhaul and/or a renovation of an aging physical store while a special project can include one or more activities less than a renovation targeted for specific activities, such as, a renovation of a department, installation of equipment, and/or another suitable improvement to physical store. For example, large retail operations can execute hundreds of remodels and special projects each year, such as 500 remodels that can average a twelve week duration and 70,000 special projects a year.

In several embodiments, block 425 can include a block 426 of estimating the respective budget for the expenditures that can include estimating a respective capital expenditure for the each of the one or more project initiatives. Block 426 can be similar or identical to the activities described in connection with blocks 704-705 (FIG. 7).

In some embodiments, block 425 also can include a block 427 of, based on the respective capital expenditure, deriving respective tier expenditures for the each of the one or more project initiatives. Block 427 can be similar or identical to the activities described in block 704-705 (FIG. 7).

In various embodiments, method 400 further can include a block 430 of determining, using a mixed integer linear programming formulation, a time window to execute the each of the one or more project initiatives. Block 430 can be similar or identical to the activities described in connection with blocks 706-707 (FIG. 7).

In some embodiments, the mixed integer linear programming formulation uses one or more constraints can include one or more of: a maximum number of total project initiatives, a maximum number of project resources for the each of the one or more project initiatives, a maximum number of project initiatives within each geographic region, and/or a maximum number of project initiatives to begin each week.

In some embodiments, block 430 further can include generating time windows to execute each project initiative using respective algorithms for each remodel and/or each special project for each physical store. In many embodiments, generating time windows can include determining the optimal dates (e.g., time windows) in which to complete each project initiative in every store. In several embodiments, time windows for a remodel and/or a special project can be based on using different processes or methods.

In various embodiments, block 430 also can include generating optimal dates for each remodel which can include using mixed integer linear programming to recommend one or more time windows during which time of year the physical store experiences lower transactions to minimize disruption of operations during a time window. In several embodiments, generating optimal dates for one or more physical stores based on operations of scale can number several thousands of physical stores operational located over multiple locations, such as a number of physical stores can include 400, 500, and/or another suitable number of scale. In several embodiments, each physical store can be one of a predetermined number of physical stores based on a respective fiscal year, a respective calendar year, and/or another suitable period of time.

In various embodiments, block 430 further can include generating optimal dates for each remodel which can include, using mixed integer linear programming based on training data. In some embodiments, training data can include historical capital expenditure, historical remodels, historical lift, historical disruption, and/or historical physical store data. In several embodiments, an output based on the training data can include a respective range of time (e.g., weeks) used for scheduling the remodel for each physical store.

In many embodiments, block 430 additionally can include selecting a set of physical stores for remodels to be performed during a time period. In some embodiments, such a time period can be divided into three slots or waves, where remodels for the physical stores can be assigned to one of the three slots. For example, every year about 500 physical stores are selected for a remodel. The goal to find optimal dates to schedule each of the remodels can be based on a preference of the physical store, weekly transactions, and/or another suitable consideration. In many embodiments, a year can be divided into three slots (waves), where physical stores can input preferences over a preferred slot for the remodel.

In several embodiments, block 430 also can include generating time windows to schedule remodels, using mixed integer linear programming, which can include using objective functions and following one or more constraints. In some embodiments, objective functions can include a time period where the average number of transactions for each physical store is at a minimum transaction level. In many embodiments, another objective function can include preferences by physical stores for which slot or wave to perform the remodel.

In some embodiments, block 430 further can include generating time windows to schedule remodels, using mixed integer linear programming, which can include one or more constraints. In several embodiments, a location constraint can include a maximum number of physical stores from a region or market location can be remodeled during each wave. For example, in a wave, at most one store from a market can be remodeled. In some embodiments, a wave constraint can include a maximum number of remodels to be performed across the United States. For example, across the United States, a wave of not more than 200 stores can be remodeled. In various embodiments, a start date constraint can include a maximum number of remodels to begin during particular time period. For example, not more than 30 remodels can start in a week. In many embodiments, an optional constraint can include a maximum number of remodels during a given period not to exceed a threshold number. For example, a maximum number of project initiatives (e.g., remodels) in any given week can be less than 10,000, which can be configurable through the graphical user interface (e.g., 1000 (FIG. 10)).

In some embodiments, block 430 additionally can include generating combinations of different time windows for hundreds of physical stores given a limited number of potential time windows within a predetermined period of time, simultaneously. In several embodiments, generating respective combinations of different time windows can be based on one or more considerations and/or constraints for each of the remodels. For example, evaluating a combination of 500 stores for 30 possible time windows can include evaluating a complexity of 100,000 selection variables within a few minutes, such as 1 minute, 2 minutes, 3 minutes, or in real time, and/or another suitable period of time. In this example, running each of the different scenarios in each of the combinations can include changing a duration of a time window, a number of projects of the remodel, and/or another suitable option.

In a number of embodiments, block 430 can includes implementing one or more considerations and/or constraints for each of the project initiatives which can include: one or more of a number of project initiatives starting at any given time, a number of project initiatives currently being implemented at any given point during the lifecycle of the project initiative, a predetermined location between physical stores (e.g., a spatial aspect). In some embodiments, a constraint can include implementing one remodel during a time window for each physical store located within a predetermined threshold distance of another store. For example, such a constraint can include evaluating each request for a remodel for a particular time window for implementation as long as there are no other remodels or requests for remodels ongoing within a predetermined threshold distance during the same particular time window.

In various embodiments, block 430 also can include automatically scheduling time windows, using mixed integer linear programming, which can be advantageous by providing a reduction in time used due to manual efforts in reviewing or deciphering the thousands of potential combinations of project initiatives for physical stores and possible start dates. In some embodiments, another advantage can be shown by the reduction in disruption of operations and transactions during the time window by choosing store and date combinations with lowest transactions to minimize operation disruption during that time window. In several embodiments, another advantage can include efficient resource utilization by reducing dependence on external vendors. In many embodiments, spatially planning remodels in a given region or location can be advantageous by enhancing user satisfaction when nearby stores are not remodeled at the same time in the same region to ensure user experiences are not hampered or affected.

In various embodiments, block 430 further can include scheduling time windows using one or more considerations as input by: identifying upcoming projects, identifying eligible dates for projects based on scenario-based options for holidays, blackouts, and/or another suitable type of scenario, calculating potential sales during eligible dates, considering a number of project initiatives starting at any given point of time to reduce pressures on other departments, considering the number of project initiatives occurring at any given point of time to reduce pressures on the field location and associates, and/or removing scenarios where nearby supercenters are remodeled at the same time as other physical locations.

In various embodiments, block 430 also can include generating time windows for special projects which can be based on using mixed integer linear programming. In some embodiments, training data can include data from historical capital expenditure, historical special projects, historical lift, historical disruption and/or historical physical store data. In several embodiments, an output based on the training data can include a respective range of time (e.g., weeks) used for scheduling the special project for each physical store. In a number of embodiments, for each time period, a set of physical stores can be selected for a variety of special projects associated with a service, an upgrade, and/or another suitable special project.

In several embodiments, method 400 also can include a block 435 of generating one or more respective recommendations for the each of the one or more project initiatives for a predetermined time period. Block 435 can be similar or identical to the activities described in block 620 (FIG. 6).

In several embodiments, block 435 also can include generating recommendations on whether or not to select a project initiative for execution during a particular time period (e.g., a year). In a number of embodiments, block 435 also can include automatically generating recommendations for project initiatives for a time period (e.g., 12 months) in advance of a projected start date. In several embodiments, block 435 further can include one or more activities associated with a site selection model, capital expenditures, scheduling, and/or assignments.

In some embodiments, block 435 also can include generating the optimal dates to schedule special projects which can include bundling of special projects by scheduling the new special projects alongside the existing special projects. In many embodiments, bundling can be advantageous by minimizing operation disruption, avoiding redundant permit costs, reducing travel time, utilizing resources efficiently, and/or another suitable advantage for bundling. For example, if physical store x is scheduled to have a remodel and/or a special project, such as an EOTF, combining the two projects for the same physical store can include either scheduling both project initiatives for the same time window or scheduling each to be conducted consecutively.

In various embodiments, block 435 further can include generating time windows to schedule special projects using mixed integer linear programming which can include using objective functions and following one or more constraints. In some embodiments, objective functions can include a time period where the average transactions for each physical store is at a minimum transaction level. In many embodiments, another objective function can include determining associate availability for each region where the physical store is located, where the number of associates available during a given time exceeds a threshold for a minimum number of associates, such as 20, 30, and/or another number of associates. In various embodiments, another objective can include minimizing the drive and/or commute distance for associates assigned to a physical store location.

In many embodiments, block 435 additionally can include generating a bundle score for one or more special projects and/or a combination of a project initiative and one or more special projects. In some embodiments, a bundle score that exceeds a bundling score threshold can indicate that a bundling date is available for the bundled project initiatives.

In some embodiments, block 435 also can include generating time windows to schedule special projects, using mixed integer linear programming, which can include a project constraint, a resource constraint, and/or another types of scheduling constraint. In several embodiments, a project constraint can include a maximum number of project initiatives of a same type can be in progress within a same period of time. For example, no more than 30 projects of the same type can be going on in the same week. In some embodiments, a resource constraint can include a maximum number of resources used at a same time based on rules determining a number of resources used by each project initiative. Such resources can include a number of associates, managers, and/or supervisors. For example, no more than 1,265 resources can be engaged at a time.

In several embodiments, block 435 also can include assigning, using mixed integer linear programming, associate work schedules for a duration of a project initiative during the time window for the project initiative. In many embodiments, training data can include historical associate work schedules, historical physical store remodels, and/or historical physical store special projects. In various embodiments, output based on the training data can include mapping an associate schedule with a physical store for a duration of the time window.

In several embodiments, block 435 further can include, for each time period, assigning an associate to each of the project initiatives for specialized teams assigned a group of physical stores within a radius of a particular region and non-specialized teams assigned to other physical stores. In some embodiments, assigning an associate to either a specialized team for a group of physical stores or a non-specialized team assigned to other physical stores can be performed separately. In various embodiments, a group of particular stores in a region or market can form a group of physical stores assigned to a specialized team. In a number of embodiments, an associated assigned to a specialized team can work on the physical stores that are part of the group of particular physical stores in a region or market. In some embodiments, a group of particular physical stores can include bundling of physical stores by market or region, which can advantageously increase efficiency of assigning associates. In some embodiments, one or more associates can be assigned to a physical store in a non-specialized team.

In various embodiments, block 435 also can include assigning, using mixed integer linear programming, associate work schedules can include an objective function and constraints. In some embodiments, an objection function can include minimizing respective drive or commute distances for each associate assigned to each project initiative. In several embodiments, an associate constraint can include a maximum number of associates assigned to each project initiative. For example, an associate can be assigned to one project at a time. In a number of embodiments, a resource constraint can include assigning a maximum number of resources based on a template for the project initiative. For example, every project initiative can be assigned at most X resources where X comes from a template.

In various embodiments, block 435 further can include a block 440 of sending instructions to display the one or more respective recommendations on a graphical user interface, wherein the graphical user interface displays a respective status of each of the one or more respective recommendations. Block 440 can be similar or identical to the activities described in block 710 (FIG. 7) block 802 (FIG. 8) and/or block 908 (FIG. 9).

In many embodiments, block 440 can include displaying a status indicator for each stage of the lifecycle span of each project initiative on a graphical user interface. In several embodiments, status indicators for each project initiative can be similar or identical to the activities described on graphical user interface 1000 (FIG. 10, described below). In many embodiments, status indicators can include (i) shapes such as flags, icons, bars, and/or another suitable shape and/or (ii) multiple colors representing a type of recommendation for that project initiative at a particular time. Such indicators can be dynamic and updated in real time prior to receiving a final recommendation and/or a start date for execution. For example, recommendations can be based on selecting a program year (e.g., 2021), associate availability weightings percentages (e.g., 20%), sales weightings percentages (80%), adjusting dates configurations (optional) and/or adjusting mixed configurations (optional).

In some embodiments, block 440 also can include executing each project initiative during a time window. In several embodiments, block 440 further can include calculating performance metrics using data tracked during and after execution of each project initiative. In various embodiments, executing each project initiative can include using a test vs a control approach. In some embodiments, creating a baseline can be based on historic transactions of the physical store undergoing the project initiative. In various embodiments, creating a separate baseline for collective control stores can be based on using an average of the collective control stores. In some embodiments, using the collective control stores, each control store can be compared to a control store baseline corresponding control store transactions during a performance period. In several embodiments, calculating the difference between the control stores and the baseline can factor in an expectation that the physical store can perform at a transaction level. In various embodiments, calculating performance metrics can include comparing an expected performance to actual performance in the performance analysis period. For example, before a project can be started, a physical store can be growing at 3% (baseline) and control stores can be growing at 2% (control baseline). In the analysis period, the control stores can then be growing at 3%. In this example, the difference between the control analysis period and baseline period can be 1% (3−2). Thus, in this example, the physical project store can be projected to grow an additional 1% estimating an expected growth of 4% (3+1). In this example, calculating the performance of the physical store can include a comparison of the physical store actual transaction performance to the expected 4% growth.

In many embodiments, performance metrics and/or learnings can be used as feedback to retrain and/or update various models, such as the site selection model. In several embodiments, performance metrics can include determining one or more control stores based on historical data of similar project initiatives conducted at the one or more control stores. In various embodiments, block 445 further can include calculating one or more impact metrics for each project initiative. In some embodiments, calculating a project initiative impact can include identifying a set of sister stores, using k-nearest neighbors (KNN), to calculate the impact metric of a first physical store using a sister store as a reference metric or control metric.

In several embodiments, block 445 additionally can include calculating an initiative impact of each project initiatives can be based on performance metrics of target physical stores. In some embodiments, calculating the performance metrics of the target physical stores can include determining the difference between treatment and control groups. For example, an output from a sister store model can dynamically sets 8-20 control stores per treatment group.

For example, a set of requests for remodels and/or special projects are received for processing to determine whether or not the remodel can be approved for a physical store 12 months in advance of a start date. In following the example, selecting the set of physical stores, using the site selection model, can be limited to 500 stores for a remodel. In this example, as each remodel of the 500 remodels gets closer to execution during the 12 months, requests for revisions can be reviewed in consideration of certain scenarios. Adjustments can occur 2-6 months in advance of the execution date. In this example, such a scenario can include a decision to stop (e.g., halt) remodels for 2 months due to Covid-19 outbreaks in March. Thus, all remodels can be rescheduled to occur in following months such as April and May, including reassigning associates. Further following the example, collecting data to calculate sales disruption metrics during the project and/or lift metrics post execution of the project. In this example, the disruption and lift metrics can be saved and used as the dependent variables for predicting disruption and lift as part of the site selection model. Selecting control stores can be conducted by selecting the best similar stores (e.g., sister stores) to be used as a benchmark metric. Generating data for remodel performance can include calculating weekly performance metrics.

In some embodiments, method 400 optionally can include a block 445 of calculating an impact metric of the project initiative on the first physical store compared to another impact metric on a sister physical store, using k-nearest-neighbors. In many embodiments, block 445 can be performed upon execution of a project initiative of the one or more project initiatives for a first physical store of the physical stores. Block 445 can be similar or identical to the activities described in blocks 904, 905, and 906 (FIG. 9).

In various embodiments, block 445 can include automating a project initiative (e.g., a remodel or special project) lifecycle by implementing a remodel and/or special project within a physical store. In several embodiments, projecting a completion time for each remodel can be about 13 weeks. In various embodiments, projecting a completion time for each special project can be dependent on the type of special project. For example, a special project can include updating a department with new technology, rebuilding internal structures, updating interior or exterior structures, and/or another suitable construction project.

In some embodiments, block 445 can include selecting multiple project initiatives to be implemented for multiple physical stores can include implementing a set of rules (e.g., parameters) for each store location and/or constraints. As an example, on a large scale, the number of project initiatives selected for execution each year can involve hundreds of remodels and thousands of special projects. For example, such numbers can total more than 500 remodels and/or more than 70,000 special projects in one year.

In several embodiments, block 445 also can include scheduling an optimal time window for executing each project initiative which can be challenging given a volume of project initiatives and/or the geographic proximity to each store. In many embodiments, constraints can include limiting a project initiative to a physical store located within a particular geographic area and/or region before implementing other project initiatives to minimize disruption of operations of the physical store and/or sister stores nearby. Other constraints can include seasonal weather conditions specific to geographic locations. For example, when multiple project initiatives of various sizes and timeframes are approved for implementation annually, each physical store is located within a certain distance from each other where the other physical stores remain in full operation for minimal disruption of each physical store during the project initiative. In many embodiments, prior to approving project initiatives, accounting for other considerations can include estimating costs of a project initiative, coordinating execution time frames, and/or assigning associates for fulfilling project initiatives, among others.

In various embodiments, feedback can include one or more types of impact metrics of the physical store, including the impact metric for sales disruption, sales lift, user visits, user basket sizes, and/or another type of impact metric.

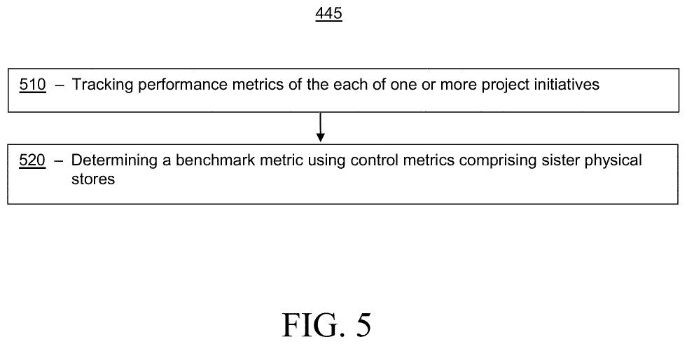

Jumping ahead in the drawings, FIG. 5 illustrates a flow chart for a block 445 of calculating an impact metric of the project initiative on the first physical store compared to another impact metric on a sister physical store, using k-nearest-neighbors, according to an embodiment. In some embodiments, upon execution of a project initiative of the one or more project initiatives for a first physical store of the physical stores, block 445 can be a method of calculating an impact metric of the project initiative on the first physical store compared to another impact metric on a sister physical store, using k-nearest-neighbors. Block 445 is merely exemplary and is not limited to the embodiments presented herein. Block 445 can be employed in many different embodiments and/or examples not specifically depicted or described herein. In some embodiments, the procedures, the processes, and/or the activities of block 445 can be performed in the order presented. In other embodiments, the procedures, the processes, and/or the activities of block 445 can be combined or skipped.

Referring to FIG. 5, block 445 can include a block 510 of tracking performance metrics of the each of one or more project initiatives. Block 510 can be similar or identical to the activities described in blocks 904, 905, and 906 (FIG. 9).

In some embodiments, block 445 also can include a block 520 of determining a benchmark metric using control metrics comprising sister physical stores. Block 520 can be similar or identical to the activities described in blocks 901-902 (FIG. 9). In several embodiments, data from the sister stores can be used in counterfactual analysis for calculation of initiative impact of a first physical store. In various embodiments, selecting sister stores that resemble the actual physical store in terms of transactions and trends can be based on one or more features including physical store demographics, user demographics, transaction specific features, project initiative specific features, and/or another suitable feature.

Returning back to FIG. 4, in several embodiments, method 400 also optionally can include a block 450 of transmitting feedback of the impact metric of the project initiative on the first physical store to a site selection model to be used as training data. Block 450 can be similar or identical to the activities described in block 645 (FIG. 6).

In a number of embodiments, block 450 additionally can include selecting a set of physical stores, using a site selection model, for a remodel. In various embodiments, selecting the set of physical stores can include pre-selecting candidate physical stores based on one or more inputs, such as estimated sales lift, disruption of class, and estimated expenditures.

In some embodiments, block 450 further can include recommending the set of physical stores for remodeling in an upcoming predetermined time period can be subject to one or more constraints provided by the user. In several embodiments, the one or more constraints can include a number of stores, a budget cap, a list of mandatory and/or excluded stores from a user, a maximum number of stores per market, an upper bound for levelling remodels across senior directors. For example, a maximum number of stores can be three stores per market.

In various embodiments, the recommendations for the set of physical stores can be based on including mandatory physical stores that can be expressed as:

YSLT>=9

where YSLT refers to Year since last touch, which can be the last time the physical store underwent any construction (e.g., a major touch), such as a remodel, a relocation, an expansion, and/or any other suitable construction. In many embodiments, YSLT can be used as a metric to determine whether to include or exclude a physical stores for selection during a time period.

In some embodiments, the recommendations can be based on excluding physical stores that can be expressed as:

YSLT<5 or SPC<=0

where SPC refers to a store profit contribution (e.g., a measure of profitability of the store.)

In many embodiments, block 450 further can include displaying an output based on the site selection model can include a list of recommended stores for a remodel during a predetermined time period.

In some embodiments, block 450 also can include updating the site selection model with certain performance metrics such as a disruption metric, a lift metric, or the respective budget for the expenditures in real time, an n number of weeks per time period, and/or another suitable time period. In some embodiments, the site selection model also can include using constraints, such as, a maximum of number of candidate physical stores within a geographical area. In several embodiments, the site selection model further can include using an objective function of scaled measures based on two decision drivers, wherein the two decision drivers comprise (i) a measure of profit and (ii) a measure of need of the project initiative. In many embodiments, the disruption metric is based on data obtained during execution of the each of the one or more project initiatives. In various embodiments, the lift metric is based on data obtained after execution of the each of the one or more project initiatives.

In several embodiments, block 450 further can generate a combination of the scaled measures of the two decision drivers expressed as:

Profit=(Sales−Avg Disruption)*SPC*(3.5−Lift Class)

Need of RM=(Total Est. Exp.)*YSLT

Objective Function=C1*Measure of Profit+C2*Measure of Need of Remodel

where Avg. Disruption refers to average disruption, a Lift class refers to a Lift estimate from the predictive model, RM refers to a remodel, C1 refers to a parameter entered by a user to specify the weighting or importance of profit (0-100%), and C2 refers to a parameter entered by the user to specify the weighting or the importance of need (0-100%).

In various embodiments, each of the two decision drivers can be scaled between 1 to 100 by finding a min and a max amongst all the candidate physical stores before the objective function is calculated. In some embodiments, parameters of the two decision drivers can be tuned by the user as per the case analysis. In several embodiments, a measure of profit and a measure of need can be set to different scales. For example, a measure of profit can be on a scale of millions while a measure of need can be on a scale of thousands. In several embodiments, applying proper weighting can include variables can be scaled between 1-100 so that both profit and need can be on the same scale to apply proper weighting.

In some embodiments, site selection model can include using ranking to recommend physical stores for special projects based on store type and an objective to maximize for each store type. Such ranking can be expressed as:

C1*(1−Dept sales share)+C2*(1−Investment share)−(Penalty factors)*P1−(5−YSLT)*P2

where C1 represents a coefficient of a department of a store type, C2 represents a coefficient of an investment share, P1 represents a coefficient for a penalty factor specified by a user, and P2 represents a coefficient for a penalty factor for a low YSLT. In many embodiments, the respective coefficients can be adapted for each store type. For example a physical store can have a YSLT of 2 (e.g., P2) and the result of 5−YSLT=3. The value of 3 can be subtracted from the score to penalize stores that have a low YSLT value. In this example, a user can have the option to adjust a penalty factor. In the example above the factor was 1, but could be adjusted and applied through multiplication. For example, when the factor is adjusted to 2, the score can be penalized by 6 (3×2).

Turning back to the drawings, FIG. 3 illustrates a block diagram of lifecycle management engine 310. Lifecycle management engine 310 is merely exemplary and is not limited to the embodiments presented herein. Lifecycle management engine 310 can be employed in many different embodiments or examples not specifically depicted or described herein. In some embodiments, certain elements or systems of lifecycle management engine 310 can perform various procedures, processes, and/or acts. In other embodiments, the procedures, processes, and/or acts can be performed by other suitable elements or systems. In many embodiments, the systems of lifecycle management engine 310 can be modules of computing instructions (e.g., software modules) stored at non-transitory computer readable media. In other embodiments, the systems of lifecycle management engine 310 can be implemented in hardware.

In many embodiments, lifecycle management engine 310 can include a database system 316. In a number of embodiments, database system 316 can at least partially perform block 801 (FIG. 8) of receiving project initiatives approved for execution stored in a database, block 812 of storing data, block 903 of storing data, and/or block 907 of storing data.

In many embodiments, lifecycle management engine 310 can include a machine learning system 311. In a number of embodiments, machine learning system 311 can at least partially perform block 405 (FIG. 4) of generating training data for the machine learning model, block 410 (FIG. 4) determining, using the machine learning model, a cost estimate for a project initiative of the each of the one or more project initiatives based on the training data, block 415 (FIG. 4) iteratively updating the training data with the cost estimates for the each of the one or more project initiatives, block 425 (FIG. 4) estimating, using a machine learning model, a respective budget for expenditures based on respective parameters of each of one or more project initiatives associated with physical stores; and/or block 620 (FIG. 6) of determining whether or not to approve each project initiative for consideration within the set of project initiatives during the predetermined time period.

In several embodiments, lifecycle management engine 310 also can include estimating system 312. In various embodiments, estimating system 312 can at least partially perform block 425 (FIG. 4) estimating, using a machine learning model, a respective budget for expenditures based on respective parameters of each of one or more project initiatives associated with physical stores, block 426 (FIG. 4) of estimating a respective capital expenditure for the each of the one or more project initiatives, block 427 (FIG. 4) of, based on the respective capital expenditure, deriving respective tier expenditures for the each of the one or more project initiatives, block 445 (FIG. 4) of calculating an impact metric of the project initiative on the first physical store compared to another impact metric on a sister physical store, using k-nearest-neighbors, block 520 (FIG. 5) of tracking performance metrics of the each of one or more project initiatives, block 630 (FIG. 6) of adjusting one or more parameters in each project initiative prior to execution of a remodel and/or a special project, block 704 (FIG. 7) of allocating budgets for a remodel of a physical store using historical averages, block 705 (FIG. 7) of automatically estimating a capital expenditure for a special project of a physical store, block 804 (FIG. 8) of revising capital budgets for special projects and/or remodel, and/or block 805 (FIG. 8) of generating revised or rescheduled time windows addressing one or more scenario-based events.

In many embodiments, lifecycle management engine 310 further can include scheduling system 313. In several embodiments, scheduling system 313 can at least partially perform block 430 (FIG. 4) of determining, using the machine learning model, a cost estimate for a project initiative of the each of the one or more project initiatives based on the training data, and/or block 435 (FIG. 4) of generating one or more respective recommendations for the each of the one or more project initiatives for a predetermined time period, block 706 (FIG. 7) of automatically scheduling a time window for a remodel, block 707 (FIG. 7) of automatically scheduling a time window for a special project, block 708 (FIG. 7) of automatically assigning one or more associates to manage each remodel, block 709 (FIG. 7) of automatically assigning one or more associates to manage each special project, block 806 (FIG. 8) of adjusting or rescheduling a time window for a remodel by using mixed integer linear programing, block 807 (FIG. 7) of adjusting and/or rescheduling a time window for a special project by using mixed integer linear programing, block 808 (FIG. 8) of generating revised or adjusted assignments addressing one or more scenario-based events, block 809 (FIG. 9) of adjusting or rescheduling assignments for a remodel, and/or block 810 (FIG. 9) of adjusting or rescheduling assignments for a special project.

In some embodiments, lifecycle management engine 310 additionally can include communication system 314. In many embodiments, communication system 314 can at least partially perform block 440 (FIG. 4) of sending instructions to display the one or more respective recommendations on a graphical user interface, block 450 (FIG. 5) of transmitting feedback of the impact metric of the project initiative on the first physical store to a site selection model to be used as training data, block 701 (FIG. 7) of transmitting each initiative request for project initiative including a request for a remodel and/or a special project, block 701 (FIG. 7) of receiving returned initiative requests unapproved in block 620 (FIG. 6), block 710 (FIG. 7) of dynamically displaying a status of each project initiative on a graphical user interface, block 801 (FIG. 8) of receiving project initiatives approved for execution stored in a database, block 802 (FIG. 8) of a graphical user interface displaying a status of each project initiative from results, block 803 (FIG. 8) of generating revised or adjusted budget estimates addressing one or more scenario-based events, and/or block 908 (FIG. 9) of a graphical user interface displaying a status of each project initiative from results received from block 903 (FIG. 9) and block 907 (FIG. 9).

In some embodiments, lifecycle management engine 310 additionally can include execution system 315. In many embodiments, execution system 315 can at least partially perform block 510 (FIG. 5) of determining a benchmark metric using control metrics comprising sister physical stores, block 610 (FIG. 6) of processing an intake of project initiative requests for consideration of whether or not to approve a project initiative for a physical store, block 640 (FIG. 6) of executing each project initiative of the set of project initiative, block 702 (FIG. 7) of selecting a physical store for a remodel at a site, block 703 (FIG. 7) of selecting a physical store for a special project at a site, block 901 (FIG. 9) of generating a set of sister stores that are similar to each physical store, using KNN, to use one or more sister stores as control stores for remodels, block 902 (FIG. 9) of generating a set of sister store to each physical store, using KNN, to use one or more sister stores as control stores for special projects, block 904 (FIG. 9) of tracking data for a period of time measuring remodel performance metrics, block 905 (FIG. 9) of tracking data for a period of time measuring special projects performance metrics, and/or block 906 (FIG. 9) of forecasting remodel capital budgets using historical averages.

In several embodiments, web server 320 can include a web page system 321. Web page system 321 can at least partially perform sending instructions to user computers (e.g., 350-351 (FIG. 3)) based on information received from communication system 314.

In some embodiments, providing a process oriented, intelligent data driven approach that can be advantageous for executing multiple tasks associated with project initiatives in a seamless manner. In several embodiments, a feedback loop can be integrated to capture real-time responses of users which would be consumed by the lifecycle management engine to improve future processes which can be non-existent by manual methods, thus an improvement over a technical field of executing project initiatives, particularly on a large-scale basis. In various embodiments, selecting sites for project initiatives were tasks generated across various teams. In some embodiments, using various teams lacked implementation of standardized approaches where teams often spent weeks to manually estimate budgets, schedule projects, and assign associates to execute the project initiatives on a small scale. Further, scattered processes based on spreadsheet data limited options to generate automated and/or intelligent recommendations. Sub-optimal schedules can include increased user disruption and increased costs. Sub-optimal assignments often led to double booked associates, increased costs in travel and labor over previously estimated budgets. Additionally, by using manual processes, no learning could occur from one year to the next for future improved processes.

In some embodiments, using an automated solution that delivers a lifecycle view and recommendations on project initiatives including project budgets, expenses, retail performances, disruption or impact to the operation. An improvement over the conventional technology can be shown as the lifecycle management engine is powered by one or more ensembles of data science algorithms. The lifecycle management engine can serve as a central point for new project planning and capital investment management by incorporating optimization models to forecast project timelines, key milestones, and capital budget across a project portfolio. Further, the lifecycle management engine can coordinate work plans and associate schedules per physical store. In short, the lifecycle management can integrate data science with visual analytics on the lifecycle of capital investment projects.

In many embodiments, establishing an automated capital estimation process for each project initiative can be advantageous to drive better utilization of overall budgets and reduce associate hours spent on the estimation process. In several embodiments, recommending an optimal list of physical stores in a rank-ordered fashion can be advantageous to the selection process by using a comprehensive approach in generating ranks by incorporating attributes like store performance, both holistic and department wise, previous investments, physical layout, lease tenure, and/or other such attributes.

In various embodiments, determining an optimal timeline for scheduling project initiatives such as recommending a particular timeline can be advantageous in selecting a favorable window of minimal operation disruption to safeguard unhindered user experiences. Such an advantage allows schedules to be spaced out across a year thereby providing for enough internal resources to be available for fulfilment and reduced dependency on third-party resources. In some embodiments, after the schedules are determined, the solution looks at optimal assignment of associates to the stores. Such an assignment module takes into account details including a commute distance for associates assigned to that region from the physical stores ready to be implemented and availability and personal time off schedules of each potential associate. Such an advantage can minimize traversing long distances and thus reduce travel costs accordingly. Such results can be displayed on a graphical user interface, such as graphical user interface 1000 (FIG. 10). Further, an advantage can include tracking data for users to consume as feedback.

In some embodiments, one advantage of using a one stop solution that can address the challenges of site selection, budget estimation, scheduling time windows, and assigning associates powered by the multiple ensemble algorithms and/or machine learning techniques can be a technical improvement over manual methods. In several embodiments, such a solution can be advantages in that a unique amalgamation of various machine learning techniques, mixed integer linear programming, predictive modelling, linear ranking, spatial analytics, and business strategy to optimize the management of store initiatives can be utilized saving time and computer resources. In various embodiments, prior to executing the project initiative, calculating lift and disruption for a proposed project initiative for each physical stores can be advantageous for optimal scheduling of the start date. In many embodiments, allocating by importance which of the various aspects and/or attributes can be considered is advantageous so as to optimally selecting physical stores for consideration during a particular year.

In some embodiments, managing initiative schedules across regions of the United States can be advantageous by avoiding peak retail time and to reduce dependency on third party vendors thus reducing overall costs of operation. In various embodiments, auto governance can be built into the algorithms so as to prioritize tasks that the retail operation should focus on with an easy view of multi-colored status colors on the display of webpage interface, such colors can include red/yellow/green. In several embodiments, by including a feedback loop to consume real-time feedback by the users for consumption by the data science engine can to improve results of recommending physical stores for selection during a particular year.

In some embodiments, using automated intelligence that can improve accuracy of delivering a comprehensive life cycle view and recommendations of which physical stores and which project initiatives can be executed each year. In many embodiments, automated recommendations can provide a seamless flow throughout the planning process increasing efficiency of the technological field. In many embodiments, self-service interfaces from users for individual scenario-based instances of various models can allow requests for revisions of budgets and/or scheduling allowing for optimal scheduling of the project initiatives.

In various embodiments, a unique amalgamation of machine learning methods for multiple stages of the process can include mixed integer linear programming, predictive models, and spatial analytics as an improvement over manual techniques.

In a number of embodiments, the techniques described herein can advantageously provide a consistent user experience by dynamically updating site selection modes with performance metrics derived from historical records for each project initiative. In various embodiments, the techniques described herein can dynamically determine whether to select a particular physical store for a remodel and/or a special project as displayed on a graphical user interface.

In many embodiments, the techniques described herein can be used continuously at a scale that cannot be handled using manual techniques. For example, the number of annual remodels and/or special projects can exceed approximately 500 and/or other suitable numbers, annually.

In a number of embodiments, the techniques described herein can solve a technical problem that arises only within the realm of computer networks, as determining whether or not to select a physical store located in a particular region minimizing disruption of operations based on rules and constraints does not exist outside the realm of computer networks. Moreover, the techniques described herein can solve a technical problem that cannot be solved outside the context of computer networks.

Various embodiments include a system comprising one or more processors and one or more non-transitory computer-readable media storing computing instructions configured to run on the one or more processors and perform certain acts. The acts can include estimating, using a machine learning model, a respective budget for expenditures based on respective parameters of each of one or more project initiatives associated with physical stores. The acts also can include determining, using a mixed integer linear programming formulation, a time window to execute the each of the one or more project initiatives. The acts further can include generating one or more respective recommendations for the each of the one or more project initiatives for a predetermined time period. The acts also can include sending instructions to display the one or more respective recommendations on a graphical user interface. The graphical user interface can display a respective status of each of the one or more respective recommendations.

A number of embodiments include a method being implemented via execution of computing instructions configured to run on one or more processors and stored at one or more non-transitory computer-readable media. The method can include estimating, using a machine learning model, a respective budget for expenditures based on respective parameters of each of one or more project initiatives associated with physical stores. The method also can include determining, using a mixed integer linear programming formulation, a time window to execute the each of the one or more project initiatives. The method further can include generating one or more respective recommendations for the each of the one or more project initiatives for a predetermined time period. The method additionally can include sending instructions to display the one or more respective recommendations on a graphical user interface. The graphical user interface can display a respective status of each of the one or more respective recommendations.

Although automatically selecting one or more respective project initiatives for one or more physical stores for execution during a period of time has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-10 may be modified, and that the foregoing discussion of certain of these embodiments does not necessarily represent a complete description of all possible embodiments. For example, one or more of the procedures, processes, or activities of FIGS. 4-9 may include different procedures, processes, and/or activities and be performed by many different modules, in many different orders, and/or one or more of the procedures, processes, or activities of FIGS. 4-9 may include one or more of the procedures, processes, or activities of another different one of FIGS. 4-9. Additional details regarding machine learning system 311, estimating system 312, scheduling system 313, communication system 314, and/or web server 320, (see FIG. 3) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions configured to run on the one or more processors and perform:
estimating, using a machine learning model, a respective budget for expenditures based on respective parameters of each of one or more project initiatives associated with physical stores;
determining, using a mixed integer linear programming formulation, a time window to execute the each of the one or more project initiatives;
generating one or more respective recommendations for the each of the one or more project initiatives for a predetermined time period; and
sending instructions to display the one or more respective recommendations on a graphical user interface, wherein the graphical user interface displays a respective status of each of the one or more respective recommendations.

2. The system of claim 1, wherein the computing instructions are further configured to perform:
generating training data for the machine learning model, wherein the training data comprises historical expenditures associated with the respective parameters of the each of the one or more project initiatives within a historical time period;
determining, using the machine learning model, a cost estimate for a project initiative of the each of the one or more project initiatives based on the training data; and
iteratively updating the training data with the cost estimates for the each of the one or more project initiatives.

3. The system of claim 1, wherein estimating the respective budget for the expenditures comprises:
estimating a respective capital expenditure for the each of the one or more project initiatives; and
based on the respective capital expenditure, deriving respective tier expenditures for the each of the one or more project initiatives.

4. The system of claim 3, wherein the machine learning model comprises an ensemble of algorithms comprising two or more of: linear regression, linear mixed model, median based model, least absolute shrinkage and selection operator (LASSO), or k-nearest neighbor (KNN).

5. The system of claim 1, wherein the mixed integer linear programming formulation uses one or more constraints comprising one or more of:
a maximum number of total project initiatives;
a maximum number of project resources for the each of the one or more project initiatives;
a maximum number of project initiatives within each geographic region; or
a maximum number of project initiatives to begin each week.

6. The system of claim 1, wherein each of the one or more project initiatives is a remodel or a special project.

7. The system of claim 1, wherein the computing instructions are further configured to perform:
upon execution of a project initiative of the one or more project initiatives for a first physical store of the physical stores, calculating an impact metric of the project initiative on the first physical store compared to another impact metric on a sister physical store, using k-nearest-neighbors, and
transmitting feedback of the impact metric of the project initiative on the first physical store to a site selection model to be used as training data.

8. The system of claim 7, wherein calculating the impact metric of the project initiative comprises:
tracking performance metrics of the each of one or more project initiatives; and
determining a benchmark metric using control metrics comprising sister physical stores.

9. The system of claim 7, wherein the site selection model uses:
inputs comprising a disruption metric, a lift metric, or the respective budget for the expenditures;
constraints comprising a maximum of number of candidate physical stores within a geographical area; and
an objective function of scaled measures based on two decision drivers, wherein the two decision drivers comprise (i) a measure of profit and (ii) a measure of need of the project initiative.

10. The system of claim 9, wherein:
the disruption metric is based on data obtained during execution of the each of the one or more project initiatives; and
the lift metric is based on data obtained after execution of the each of the one or more project initiatives.

11. A method being implemented via execution of computing instructions configured to run on one or more processors and stored at one or more non-transitory computer-readable media, the method comprising:
estimating, using a machine learning model, a respective budget for expenditures based on respective parameters of each of one or more project initiatives associated with physical stores;
determining, using a mixed integer linear programming formulation, a time window to execute the each of the one or more project initiatives;
generating one or more respective recommendations for the each of the one or more project initiatives for a predetermined time period; and
sending instructions to display the one or more respective recommendations on a graphical user interface, wherein the graphical user interface displays a respective status of each of the one or more respective recommendations.

12. The method of claim 11, further comprising:
generating training data for the machine learning model, wherein the training data comprises historical expenditures associated with the respective parameters of the each of the one or more project initiatives within a historical time period;
determining, using the machine learning model, a cost estimate for a project initiative of the each of the one or more project initiatives based on the training data; and
iteratively updating the training data with the cost estimates for the each of the one or more project initiatives.

13. The method of claim 11, wherein estimating the respective budget for the expenditures comprises:
estimating a respective capital expenditure for the each of the one or more project initiatives; and
based on the respective capital expenditure, deriving respective tier expenditures for the each of the one or more project initiatives.

14. The method of claim 11, wherein the machine learning model comprises an ensemble of algorithms comprising two or more of: linear regression, linear mixed model, median based model, least absolute shrinkage and selection operator (LASSO), or k-nearest neighbor (KNN).

15. The method of claim 11, wherein the mixed integer linear programming formulation uses one or more constraints comprising one or more of:
a maximum number of total project initiatives;
a maximum number of project resources for the each of the one or more project initiatives;
a maximum number of project initiatives within each geographic region; or
a maximum number of project initiatives to begin each week.

16. The method of claim 11, wherein each of the one or more project initiatives is a remodel or a special project.

17. The method of claim 11, further comprising:
upon execution of a project initiative of the one or more project initiatives for a first physical store of the physical stores, calculating an impact metric of the project initiative on the first physical store compared to another impact metric on a sister physical store, using k-nearest-neighbors, and
transmitting feedback of the impact metric of the project initiative on the first physical store to a site selection model to be used as training data.

18. The method of claim 17, wherein calculating the impact metric of the project initiative comprises:
tracking performance metrics of the each of one or more project initiatives; and
determining a benchmark metric using control metrics comprising sister physical stores.

19. The method of claim 17, wherein the site selection model uses:
inputs comprising a disruption metric, a lift metric, or the respective budget for the expenditures;
constraints comprising a maximum of number of candidate physical stores within a geographical area; and
an objective function of scaled measures based on two decision drivers, wherein the two decision drivers comprise (i) a measure of profit and (ii) a measure of need of the project initiative.

20. The method of claim 19, wherein:
the disruption metric is based on data obtained during execution of the each of the one or more project initiatives; and the lift metric is based on data obtained after execution of the each of the one or more project initiatives.
